(19) United States
(12) Patent Application Publication
(10) Pub. No.: US 2011/0145466 A1
(43) Pub. Date: Jun. 16, 2011

(54) MOBILE DEVICE DOCK WITH PROGRAMMABLE BUTTONS

(76) Inventors: Ari Supran, San Clemente, CA (US); Scott Struthers, San Clemente, CA (US)

(21) Appl. No.: 12/888,314

(22) Filed: Sep. 22, 2010

Related U.S. Application Data
(60) Provisional application No. 61/286,922, filed on Dec. 16, 2009.

(51) Int. Cl. G06F 13/00

(52) U.S. Cl. 710/304

(57) ABSTRACT

A docking station for a handheld computer is provided. The docking station is installed in a wall and has multiple buttons that can send command signals to the handheld computer. The buttons could be programmed to provide a variety of different signals to the handheld computer, but generally allow a user to operate and manage the computer while it is docked. The docking station can also receive commands or other signals from the handheld computer and increase the functionality of the computer, for example by projecting a movie onto a screen, by transmitting music to a remote speaker or by connecting the computer to a network. In some embodiments, multiple docking stations could be networked together to allow for a dramatic increase in the functionality of the computer.

This application claims the benefit of priority to U.S. Provisional Application Ser. No. 61/286,922 having a filing date of Dec. 16, 2009.

### FIELD OF THE INVENTION

The field of the invention is a docking unit for a mobile device.

### BACKGROUND

Portable computers have long been used for storage and playback/creation of music, video, still images, and other forms of data. As used herein, “portable computers” include, among other things, laptops, a variety of portable media players (e.g., the iPod™ and iPhone™ devices manufactured by Apple™, Inc.), cellular phones, and portable video players. Portable computers are generally used for ease of portability and to enable users to access data files while away from home. In practice, however, portable computers primarily only allow outputting of data files to a single room/zone, typically through headphones, built-in speakers and/or a built-in display.

Portable computers can also be considered lifestyle devices, which facilitate the convenient transportation of data from one source/player to another, and allow local output of music, video, and other media through associated headphones and/or built-in monitors. In general, data is uploaded to a portable computer by connecting to a data source, typically a desktop computer. Once the data is loaded on to the portable computer, the data is downloaded (played) through headphones. For example, the iPod™ has a built-in monitor and headphone port to allow for single zone/room audio/video distribution.

While portable computers are useful to record and play media, these computers fail to take advantage of the portability and other features of the computer as a source of high quality music and video. In addition, these single-zone audio systems are also typically characterized by computer-specific docking stations connected to a local amplification/speaker distribution system.

The evolution of home entertainment systems has seen the introduction of sophisticated digital signal processors, adapted to interface with a wide range of audio/video equipment, and controllers therefore. Such equipment includes the Sonance Model DAB 1 audio controller/amplifier, the Sonance Navigator Harbor switch and the Sonance Navigator K1 and K2 controllers, marketed by Dana Innovations. Such equipment allows for selective distribution of audio programming about a multi-zone system, with local zone controllers operative to regulate local, remote or system wide operation. The distribution of such controllers about the audio system allows for distributed control of the audio system from any zone.

A useful enhancement to contemporary audio/video systems would be an apparatus which allows the flexibility, sophistication and audio/video reproduction quality of multi-zone media systems to be merged with the convenience and portability of portable computers. In this manner, the lifestyle qualities of the portable computer can be used to enhance the enjoyment of the multi-zone media entertainment system. In addition, because many contemporary portable computers have unique shapes or electrical interfaces, there is a need in the art to interface the portable computers to the entertainment system in order to accommodate different portable computers, both mechanically and electrically.

Additionally, there is a need in the art to provide a device which can readily interface with a variety of different portable computers without the need for a computer-specific electrical interface and control system. There is also a need for infrared (IR) or radio frequency (RF) control systems that respond to signals from various receiver locations to regulate operation of the portable computer, whether disposed locally or remote from a user and without the need for development of a unique electrical interface or any modification of the device's circuitry.

Further, there is a need for an interface that is wall mountable to facilitate convenient viewing of the portable computer and facilitate access to manual controls of the portable computer.

It is further desirable that the multi-zone entertainment system allow for engagement to a plurality of portable computers, whereupon audio and/or video inputs from each of the portable computers are selectively communicated to different zones of the multi-zone entertainment system, for simultaneous distribution of different audio/video programming to different audio/video zones. U.S. patent application Ser. No. 12/357,286 filed on Jan. 21, 2009, discusses multi-zone entertainment systems.

GB Patent No. 2429573 to Booth teaches a network of docking stations connected to a server within a home or office. Multiple handheld devices can connect to the network server via the docking stations, allowing the server to access media stored on the handheld devices as if it were one unified media library. The server's software allows for outputting media, such as songs or videos, to various zones within the house. The docking stations also provide electrical power to the handheld devices and can re-charge the devices' batteries. However, the docking stations do not provide controls for operating a handheld device locally while the device is docked, and require space on bookshelf or counter top to operate the dock.

The present invention is directed to achieving these and other goals within a simple, configurable device that consumes no table space and can be architecturally compatible with flush-mounted in-wall/in-ceiling audio and video systems.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for mobile device docking station that provides buttons for controlling the device while it is docked.

### SUMMARY OF THE INVENTION

The present invention provides apparatus and methods in which a docking station for docking a handheld device at a wall comprises: (i) a wall-mountable body portion, (i) a connector that could electrically couple the docking station and the handheld device; and (iii) a controller that could allow a user to provide a command to the handheld device through a plurality of control buttons disposed within the body portion that corresponds to a function of the handheld device.

Preferred handheld devices include handheld devices such as the iPod™, iPhone™ iPad™, Blackberry™, Palm Pilot™, PDAs, and other portable media players and battery operated electronic devices such as laptop computers. It is contemplated that preferred handheld devices could store and execute software applications, enhancing the functionality of the devices. It is further contemplated that preferred handheld devices can serve as a remote control for various other electronic device through various software applications. It is also contemplated that the handheld devices can have various and unlimited functions corresponding to a particular software applications. Such contemplated functions can include but is not limited to baby monitors, grill temperature gauges, etc. Such software applications can be built in to the handheld devices or available for download to the handheld devices through various mediums.

A “battery” is defined herein to include any electrochemical cell that stores usable amounts of electrical energy. The term “battery” excludes capacitors. As defined herein, a device is “portable” when it is less than 160 ounces, and more preferably less than 80 ounces, and even more preferably less than 30 ounces.

The body portion of the docking station could be made of any commercially suitable material, such as metal, wood, plastic, composite, or any combination thereof. In one embodiment the body portion is plastic and is sized and dimensioned to extend within the wall to provide an in-wall dock. The body portion could also be sized, dimensioned, and positioned so that, when the handheld device is docked, the front of the device is flush mounted to the wall. Flush mounting the docking station advantageously integrates the station within the building structure, providing a clean esthetic appearance. The body portion can also include features for facilitating installation of the docking station, such as screw holes, brackets, or any other commercially available means for installing fixtures. Additionally, the body portion of the docking station can include a window that allows a user to access a touch screen portion of the handheld device.

The connector is a physical interface that carries power to the handheld device and recharges the device's charger battery. The connector could provide power to the handheld device in any suitable manner, including wirelessly or through a battery interface, and such power can be used directly to operate the handheld device, or indirectly by charging a battery within the handheld device. In an especially preferred embodiment, the battery in the handheld device is only charged when its voltage drops below a specified threshold. The charger battery could also be recharged in any suitable manner, either wirelessly or through a wired interface, and either while it is contained within, or removed from, the charger. Preferably, however, the charger battery is recharged while still connected to the docking station, and while the docking station is receiving power through a wired connection from a wall socket.

The connector also allows the handheld device to communicate with the controller. It is contemplated that the connector include two separate interfaces; (i) a data interface for communicating with the controller and (ii) a battery interface for providing power to the handheld device. It is also contemplated that the connector could comprise a single interface that provides both power and a data communication link to the handheld device. Preferably, the connector is configured to exchange or transfer data, such as music, videos, and electronic documents with the controller. Additionally, the connector could be configured to send or receive commands, such as “play,” “record,” “select,” “save,” or “execute” to and from the controller. In one embodiment the controller comprises a button mechanically connected to a button on the handheld device. The docking station could include more than one connector for interfacing with handheld devices of different formats, particularly for handheld devices that use proprietary interfaces.

The controller preferably communicates with another device, such as a home computer, media server, a second handheld device, or an output device such as an audio speaker or display screen, thereby enhancing the functionality of the handheld device. This allows transferring of data between the handheld device and other devices. For example, the controller could communicate with the other device via a wireless transceiver, infra-red transceiver, a radio frequency transceiver, an Ethernet cable, a universal serial bus, or any other commercially available means for establishing electronic communication. The controller could also interface with a user via a tactile interface, such as a touch pad, a heat-sensitive pad, a spring button, a scroll-wheel, and any other suitable control interface. It is also contemplated that the controller could comprise an audio receiver that recognizes a user's verbal commands or a bar-code reader that responds to scanned bar codes.

In an especially preferred embodiment, the controller is an application that is installed on the handheld device itself. An “application” is defined herein as any software that can be transferred to the handheld device and executes on an operating system installed on the handheld device. The application preferably displays the controller interface on a visual touch-pad screen on the handheld device, and has customizable control buttons that can be “macroed” to perform any number of tasks.

Preferably, the other device that the controller communicates with is a remote electronic device. A “remote electronic device” is defined herein as one that is not physically attached to the handheld device or to the docking station through a wired connection, while the transmitter is being used. It is contemplated that the transmitter could be configured to send any type of data, including for example, an audio stream received from the handheld device, an encoded file, or most preferably a command to the remote electronic device. It is also contemplated that the transmitter could also receive information from the remote electronic device, and relay that information to the handheld device. In such instances the transmitter would operate as a transceiver.

A “transmitter” is any device that transmits information using a wave form. While the transmitter could transmit information using a visible, ultraviolet or infrared frequency, preferred transmitters use radio waves because they tend to have greater range. The frequencies used in the contemplated docking stations fall outside of the AM/FM radio waves in order to avoid any interference. As used herein, AM waves are defined as all frequencies between 520 kHz and 1710 kHz, and FM waves are defined as all frequencies between 65.8 MHz and 108 MHz. In an especially preferred embodiment, the transmitter sends and receives data at one or more radio frequencies over 1000 MHz.

A tracking module in the docking station or installed on the handheld device could be used to detect a distance between the handheld device and another electronic device with which the controller is communicating. Any suitable method of obtaining a distance measurement could be used, for example using RFID triangulation with repeaters, or calculating a distance based upon the length of time it takes for the remote electronic device to respond to a “ping” signal from the transmitter. The combined docking station and handheld device could then control the electronic device based upon this distance. For example, the combined devices could initiate a “follow-me” mode, where speakers in a room fade in and out depending on how far the docking station is from the remote electronic device.

In one embodiment the controller is removable from the docking station and can be used to remotely control the handheld device. In yet another embodiment, a plurality of docking stations are connected together via their respective controllers, forming a network of docking stations. The network could be managed by a central server or network management could be distributed. A network connecting multiple handheld devices advantageously allows data from multiple sources to be accessed as one large media library. The network further provides a multi-zone entertainment system in which media data can be accessed simultaneously from different zones throughout the network.

In yet another embodiment the docking station can connect to a personal computer connection. The personally computer connection is preferably different from the control buttons.

Preferably, the docking station is compatible with a variety of handheld devices having different shapes and sizes. In one embodiment the docking station has a mounting frame with a well into which the handheld device can be positioned. The mounting frame could be removed from the docking station and replaced with a second mounting frame that is compatible with different handheld device. In another embodiment the docking station has a cradle shaped and configured to accommodate different models of a handheld device. The cradle comprises a recess in the docking station that is shaped to surround a perimeter of the handheld device, so that the two devices appear as a single device to a casual observer. In some alternative embodiments, the docking station could be formed as a detachable travel case for the handheld device. A given docking station could have interchangeable cradles with different interfaces to accommodate different handheld devices.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a front view of a docking station as a monitoring device in accordance with one aspect of the invention.

FIG. 2 is a front view of a docking station mounted on a grill in accordance with one aspect of the invention.

FIG. 3 is a front view of a docking station in accordance with one aspect of the invention.

FIG. 4 is a front view of a docking station in accordance with one aspect of the invention.

### DETAILED DESCRIPTION

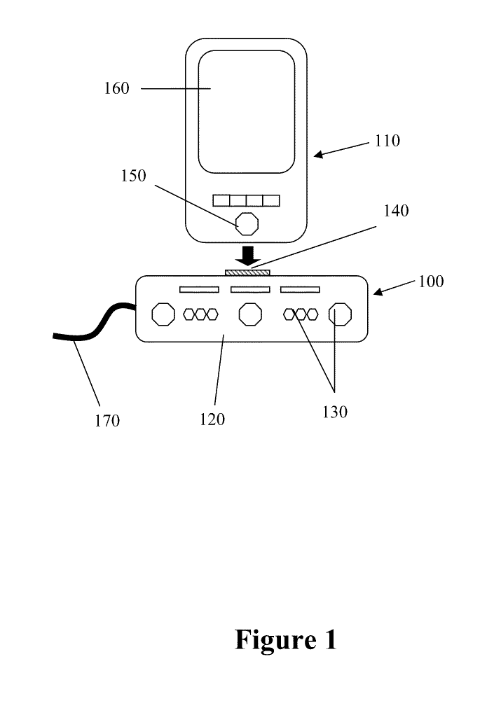

FIG. 1 shows a docking station 100 and a handheld device 110. Handheld device 110 has a camera 150 and a touch screen 160. Handheld device 110 can execute an application which allows device 110 to function as a monitoring device, much like a baby monitoring device. The docking station 100 has a controller interface 120 having a series of control buttons 130, which can be used for “viewing”, “videoing”, “playing music”, or “talking” Once handheld device 110 is connected to docking station 100 via connector 140, a user can access an appropriate application within device 100 and can operate a function of device 110 by using controller interface 120. For example, a user can start “viewing”, “videoing”, or “playing music” by pressing one of the control buttons 130. The function of each button can be displayed using an icon on the appropriate button (not shown). At the same time, docking station 100 is also charging handheld device 110 when it is docked. Docking station 100 also has a cord 170 for connecting to a power supply, such as a power outlet (not shown).

The advantages of providing control buttons 130 on controller interface 120 are numerous. First, the configuration protects the handheld device and facilitates operation of the device when it is docked. Many of the handheld devices have touch-based sensitive screens in which it is quite easy to hit the wrong buttons. Control buttons 130 ensure that the user can easily locate and execute the right command for the appropriate function. Second, the present inventive subject matter allows for compatibility and uniformity with different handheld devices. Usually, an application has to be specifically written for a specific handheld device. For example, a baby-monitoring application for an iPhone will be different from a baby-monitoring application written for a Blackberry since each phone uses different interface commands. With docking station 100, any handheld device can potentially have the same functions because control buttons 130 can be programmed to operate the same function for any handheld device. Finally, control buttons 130 allow for docking station 100 to be mounted within a wall or ceiling, creating a clean esthetic appearance.

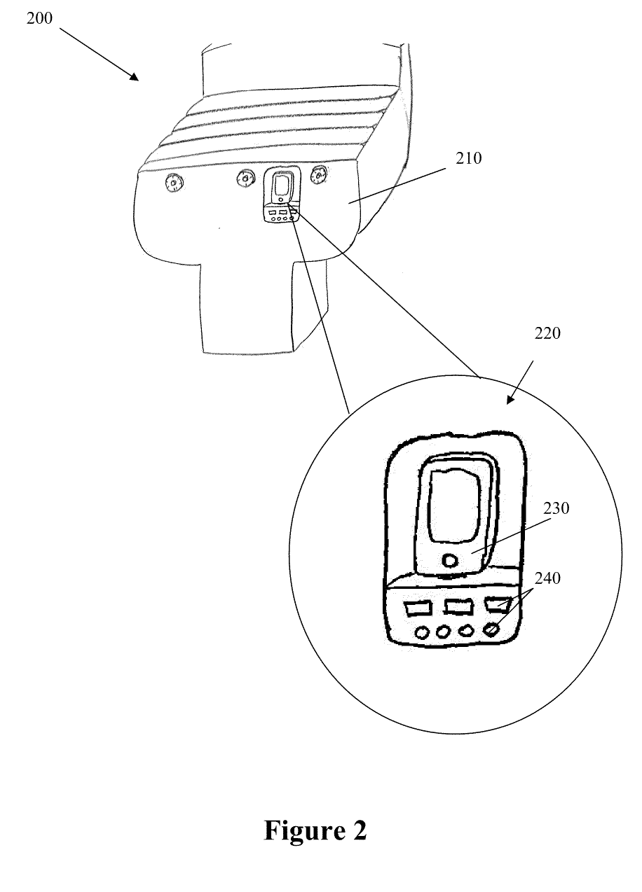

Other contemplated embodiments include having a docking station that is attached to an existing item, such as a grill. FIG. 2 shows a grill 200 having a grill housing 210. Docking station 220 is mounted within grill housing 210. A user can dock handheld device 230 on docking station 220. The user can then open up a grilling application stored on device. Control buttons 240 allow the user to operate device 230 and access the grill application. For example, the user can access images and instructions from the application that will assisting the user cooking a steak, such as “medium,” “rare”, “medium well done,” and “well-done.” Other useful functions such as a cooking timer may be included in the application and can be accessed via control buttons 240. Since control buttons 240 are programmable, any handheld device capable of electrically connecting to docking station 220 can be operated much the same way as handheld device 230. Thus, control buttons 240 advantageously provide one uniform interface regardless of whether handheld device 230 is an iPhone or Blackberry.

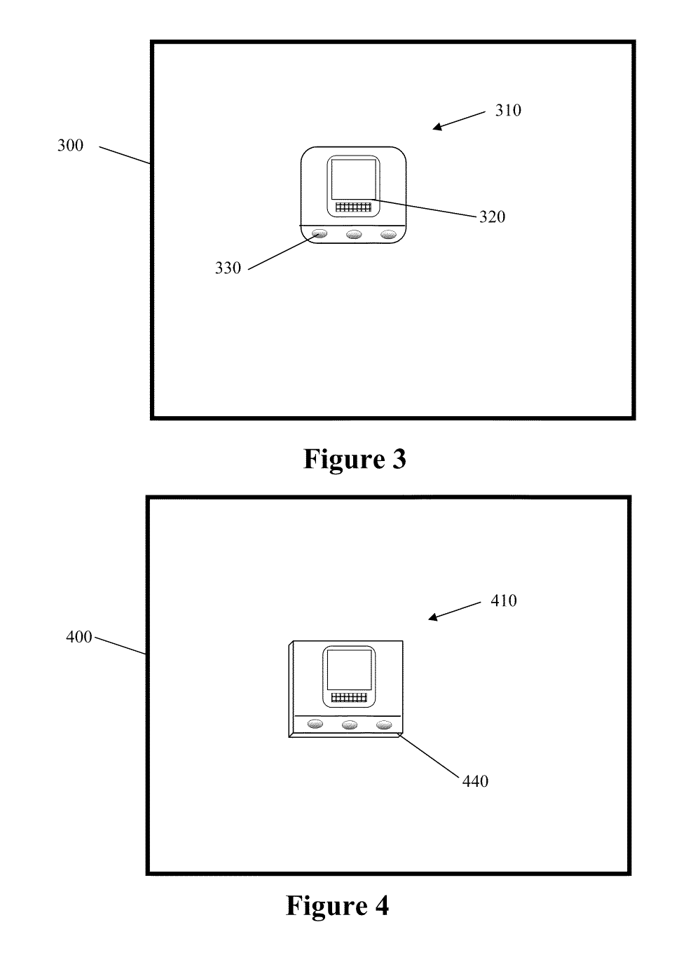

FIG. 3 shows docking station 310 flush mounted into a wall 300. Handheld device 320 is docked in docking station 310. Control buttons 330 on docking station 310 allow a user to operate device 320 while it is docked. FIG. 4 shows a docking station 410 mounted on a wall 400. Docking station 410 has a width 440. Width 440 shows how docking station 410 is mounted on top of, and protrudes from, the surface of wall 400.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A docking station for docking a handheld device at a wall, comprising:
a wall-mountable body portion;
a connector that can electrically couple the docking station and the handheld device; and
a controller that allows a user to provide a command to the handheld device through a plurality of control buttons disposed within the body portion that corresponds to a function of the handheld device.

2. The docking station of claim 1 wherein the body portion is sized and dimensioned to extend within the wall.

3. The docking station of claim 1 wherein the body portion is sized and dimensioned to be flush mounted to the wall.

4. The docking station of claim 1 wherein the connector carries power to the handheld device.

5. The docking station of claim 1 wherein the connector is configured to carry data, music and commands.

6. The docking station of claim 1, further comprising a window that allows a user to access to a touch screen portion of the handheld device.

7. The docking station of claim 1 wherein the controller comprises a wireless receiver.

8. The docking station of claim 1 wherein the controller comprises an infra-red receiver.

9. The docking station of claim 1 wherein the controller comprises a radio frequency receiver.

10. The docking station of claim 1, further comprising a wireless transmitter.

11. The docking station of claim 1, further comprising a personal computer connection circuit different from the control buttons.

12. The docking station of claim 1, further comprising a mounting frame that defines a well into which the handheld device can be positioned.

13. The docking station of claim 1, further comprising a cradle that accommodates different models of the handheld device.
